(19) United States
(12) Patent Application Publication
(10) Pub. No.: US 2004/0145314 A1
(43) Pub. Date: Jul. 29, 2004

(54) Light emitting devices having a self-cleaning function, methods of manufacturing the same, and methods of manufacturing plasma display panels having a self-cleaning function

(76) Inventors: Takehiro Zukawa, Katano (JP); Masatoshi Kitagawa, Hirakata (JP); Masaharu Terauchi, Nara (JP); Junko Asayama, Takatsuki (JP)

Correspondence Address: SNELL & WILMER L.L.P., Suite 1200, 1920 Main Street, Irvine, CA, 92614-7230, US

(21) Appl. No.: 10/712,561

(22) Filed: Nov. 13, 2003

(30) Foreign Application Priority Data
Nov. 15, 2002 (JP) 2002-331903

(51) Int. Cl. H01J 17/49

(52) U.S. Cl. 313/582

(57) ABSTRACT

A light emitting device that emits visible light caused by ultraviolet rays from a discharge generated in a discharge medium including a rare gas, wherein a phosphorous material is disposed in a vessel that is hermetically sealed and contains the discharge medium, and a photocatalyst is disposed at one or more positions inside the vessel, the positions being reachable for one or both of the ultraviolet rays and light emitted from the phosphorous material, so that the photocatalyst is in contact with the discharge medium.

### BACKGROUND OF THE INVENTION

(1) Field of the Invention

The present invention relates to light emitting devices, particularly to techniques to inhibit deterioration of luminance, which could occur over the course of time, of light emitting devices such as plasma display panels (hereafter, referred to as PDPs) and electrodeless discharge lamps.

(2) Description of the Related Art

In recent years, among various display devices used for computers, televisions and the like, PDPs are noted for their capability of realizing display devices that are large, flat, and light-weight.

A PDP is a display device that achieves color display capability through irradiating ultraviolet rays from plasma discharges generated in a gas onto phosphorous materials (red, green, and blue).

FIG. 1 is a schematic drawing of the PDP 100, which is a typical AC-type (alternating current type) PDP.

The PDP 100 comprises a front plate 90 and a rear plate 91 which are disposed so that their main surfaces oppose each other. The front plate 90 and the rear plate 91 are arranged to be on top of each other and are hermitically sealed together around the edges by fused sealing glass 190, and thereby a discharge space 116 is formed therein.

The front plate 90 comprises a front glass substrate 101, display electrodes 102, a dielectric layer 106, and a protective layer 107.

The front glass substrate 101 is the base of the front plate 90, and the display electrodes 102 are formed on the front glass substrate 101.

The display electrodes 102 and the front glass substrate 101 are covered by the dielectric layer 106, and then by the protective layer 107, which is made of magnesium oxide (MgO).

The rear plate 91 comprises a rear glass substrate 111, address electrodes 112, a dielectric layer 113, ribs 114, and phosphor layers 115r, 115g, and 115b. The phosphor layers 115r, 115g, and 115b are formed on the walls of the gaps between the ribs 114 (hereafter, the gaps between the ribs 114 will be referred to as grooves) and correspond to the colors or red, green, and blue, respectively.

A discharge gas containing a rare gas, for example, He, Xe, or Ne, is enclosed in the discharge space 116.

The area defined by a pair of display electrodes 102 positioned adjacent to each other and an address electrode 112 that intersects the display electrodes 102 with a discharge space 116 intervened therebetween is a cell that contributes to image display.

In the discharge space 116, vacuum ultraviolet rays are generated due to discharges, and the phosphor layers 115r, 115g, and 115b respectively corresponding to the colors of red, green and blue are excited and emit light. This is how color display is performed.

During the manufacturing process of the PDP 100, in order to eliminate impurity gases, an impurity gas eliminating process is performed, typically as shown in FIG. 2, by heating up the entire PDP 100 and exhausting the gas from the inside of the PDP 100. The impurity gas eliminating process is performed between the process of bonding the front plate 90 and the rear plate 91 with glass frit and the process of sealing the space inside the PDP 100.

There is, however, a limit to how completely impurity gases can be eliminated in the impurity gas eliminating process.

The reason is that most of the components of the PDP 100 are each formed by applying a mixture of a base material and an organic matter in the form of paste (hereafter, referred to as an organic paste) and baking it. During this baking process, a large part of the purity gases can be eliminated; however, it is difficult to eliminate them completely.

Even after a long period of time is spent trying to eliminate impurity gases to a sufficient level during the impurity gas eliminating process, more impurity gases may be released from those components over the course of time.

As a result, the chemical reaction develops so that the impurity gases inside the PDP 100, e.g. a hydrocarbon or carbon monoxide, change to a solid carbide or the like, due to the discharges generated inside the cells. The carbide gets distributed inside the PDP 100 and adheres to the internal wall surfaces, for example, on the surfaces of the phosphor layers and on the inside of the front panel 90.

When a carbide adheres to the surfaces of the phosphor layers and on the inside of the front panel 90, the light transmittance gets deteriorated on the surfaces of the phosphor layers as well as at the front panel 90. Consequently, there is a problem that the luminance of emitted light also may be deteriorated.

As for an electrodeless discharge lamp, metal atoms that are in a rare gas get excited by way of electromagnetic induction, and thus, ultraviolet rays are generated. The ultraviolet rays are irradiated onto a phosphorous material so that the phosphorous material emits light and thereby visible light can be obtained. Like the problem of PDPs, electrodeless discharge lamps also have a problem of deteriorated luminance of emitted light due to a carbide that may deposit, over the course of time, from the impurity gases included in the rare gas and adhere to the internal wall.

### SUMMARY OF THE INVENTION

In view of the aforementioned problems, a first object of the present invention is to provide a light emitting device wherein deterioration, over the course of time, of the luminance of emitted light is inhibited.

A second object of the present invention is to provide a method of manufacturing such a light emitting device by which the first object can be achieved.

In order to achieve the first object, the present invention provides the followings;

(1) A light emitting device that emits visible light caused by an ultraviolet ray from a discharge generated in a discharge medium including a rare gas, the light emitting device comprising: a vessel that is hermetically sealed and contains the discharge medium; a phosphorous material disposed in the vessel; and one or more photocatalysts that (i) are disposed at one or more first areas inside the vessel, the first areas being reachable for one or both of the ultraviolet ray and light emitted from the phosphorous material, and (ii) are in contact with the discharge medium.

Since the photocatalyst exerts its self-cleaning effect, mainly due to the ultraviolet rays generated in discharges, it is possible to inhibit solid substances such as a carbide from adhering to the inside of the discharge vessel, especially around the phosphorous material.

In other words, the photocatalyst decomposes by oxidation impurity gases such as hydrocarbon, as well as deposited carbides.

As a result, because there is a smaller amount of deposited substance, such as a carbide, which could hinder the ultraviolet rays to be irradiated onto the phosphorous material or the visible light emitted from the phosphorous material, it is possible to inhibit the deterioration of the luminance of emitted light.

(2) The light emitting device of (1), wherein the light emitting device is a plasma display panel, the vessel is made of at least a first substrate and a second substrate that oppose each other and are sealed together around edges thereof, a plurality of ribs are formed on the first substrate, in each of at least one of second areas provided between the ribs, the phosphorous material forms one or more phosphor layers on one or more walls that surround the second area, and at least one of the photocatalysts is disposed at one or more positions selected from (i) anywhere in the second area in which the phosphor layer is formed and (ii) at a top of at least one of the ribs that sandwich the second area in which the phosphor layer is formed.

When a carbide is adhered to the surface of the phosphorous material, since the photocatalyst and the phosphorous material are disposed in a same area, it is easier to decompose the carbide, and the effect of inhibiting the deterioration of the luminance of emitted light is enhanced.

(3) The light emitting device of (2), wherein at least one of the photocatalysts is disposed so as to be distributed throughout one or more of the phosphor layers.

Since the photocatalyst and the phosphorous material are disposed as being mixed together, when a carbide is adhered to the surface of the phosphorous material, it is easier to decompose the carbide.

(4) The light emitting device of (2), wherein the phosphor layers are porous so as to allow the discharge medium to pass through, and at least one of the photocatalysts is disposed so as to be (i) positioned between at least one of the phosphor layers and the first substrate, and (ii) in contact with the at least one of the phosphor layers.

(5) The light emitting device of (2), wherein the phosphor layers are porous so as to allow the discharge medium to pass through, and at least one of the photocatalysts is disposed so as to be (i) positioned between at least one of the ribs and the phosphor layer formed over a surface thereof, and (ii) in contact with this phosphor layer.

Typically, the phosphor layer is disposed in each of the areas provided between the ribs, and with this arrangement, the carbide is decomposed without having the light emitted from the phosphor layer being hindered.

(6) The light emitting device of (2), wherein at least one of the photocatalysts is disposed at one or more positions selected from (i) at a top of at least one of the ribs and (ii) in vicinity of such a top.

Typically, phosphor layers are not disposed at the tops of the rib; however, with this arrangement, by disposing the photocatalyst at such positions, the carbide is decomposed without having the light emitted from the phosphor layer being substantially hindered.

(7) The light emitting device of any of (3), (4), (5), and (6), wherein when absorbing an ultraviolet ray, each phosphor layer emits light in a color that is common to the phosphor layers in that second area, the color being one of red, green, and blue, and at least one of the photocatalysts has an absorption edge within a wavelength band of the color of blue in a visible light range and is disposed in vicinity of the phosphor layer that emits light in the color of blue.

Because blue has low visibility, deterioration of luminous intensity is especially obvious. Thus, there is demand that deterioration of luminous intensity of a blue phosphor layer should be as little as possible.

By setting the absorption edge of the photocatalyst within the wavelength band of blue, and making the distance between the blue light source and the photocatalyst short, it is possible to enhance the self-cleaning function of the photocatalyst so as to meet the demand.

(8) The light emitting device of any of (3), (4), (5), and (6), wherein when absorbing an ultraviolet ray, each phosphor layer emits light in a color that is common to the phosphor layers in that second area, the color being one of red, green, and blue, the photocatalysts each have an absorption edge in one of two or more wavelength bands that are different from each other, and which wavelength band the absorption edge of each photocatalyst is within is determined according to the color of the light emitted from the phosphor layer that is disposed in vicinity thereof.

With this arrangement, by setting the absorption edge of the photocatalyst within the wavelength band of the light emitted from the phosphor material that is disposed in the vicinity of the photocatalyst, it is possible to efficiently utilize the light emitted from the phosphor material for each color, and to enhance the self-cleaning function of the photocatalyst.

(9) The light emitting device of any of (3), (4), (5), and (6), wherein all the second areas each have at least one of the photocatalysts disposed therein.

With this arrangement, it is possible to dispose a larger amount of photocatalyst, and to enhance the self-cleaning function of the photocatalyst.

(10) The light emitting device of any of (3), (4), (5), and (6), wherein a main component of each of the photocatalysts is TiO₂ in anatase form.

TiO₂ in the anatase form is suitable for the photocatalyst to be used in the present invention.

TiO₂ in the anatase form is reasonably priced and also can be easily obtained; therefore, it is possible to inhibit the deterioration of the luminous intensity that could occur over the course of time, at a low cost.

(11) The light emitting device of (10), wherein at least one of the photocatalysts has an absorption edge within a visible light range.

With this arrangement, it is possible to make the distance between the photocatalyst and the phosphor layer being the source of the light having the wavelength band of visible light corresponding to the absorption edge of the photocatalyst. Typically, TiO₂ exerts its self-cleaning function due to ultraviolet rays, and with this arrangement, since the visible light from the phosphor material is also utilized, it is possible to enhance the self-cleaning function of the photocatalyst.

(12) The light emitting device of (1), wherein the light emitting device is a plasma display panel, the vessel is made of at least a first substrate and a second substrate that oppose each other and are sealed together around edges thereof, and the one or more photocatalysts are disposed outside an image display area in which the phosphorous material is disposed.

Due to the convection of the discharge gas inside the vessel, the gas that has been cleaned by the photocatalyst disposed outside the image display area will be distributed inside the image display area as well; therefore, the effect of inhibiting the deterioration of the luminance of emitted light is available.

(13) The light emitting device of (12), wherein the photocatalysts are disposed in vicinity of the edges of at least one of the first and the second substrates.

Typically, there are flat surfaces in the vicinity of the edges of the substrates for the purpose of sealing; therefore, it is easy to print or apply the photocatalyst.

In order to achieve the second object, the present invention provides the followings:

(14) A method of manufacturing a light emitting device that emits visible light caused by an ultraviolet ray from a discharge generated in a discharge medium including a rare gas, the method comprising: a precursor preparing step of preparing a precursor of a phosphor layer by mixing phosphor particles and a photocatalyst; a precursor disposing step of disposing the precursor at one or more positions being reachable for the ultraviolet ray, so that the precursor is in contact with the discharge medium; and a phosphor layer forming step of forming a phosphor layer by baking the precursor.

With this arrangement, after the phosphor particles and the photocatalyst are mixed together, when the phosphor material precursor is disposed, the photocatalyst that has been mixed therein is also disposed; therefore, it is possible to dispose the photocatalyst having a self-cleaning function in the area, without having another step of disposing the photocatalyst.

(15) A method of manufacturing a light emitting device that emits visible light caused by an ultraviolet ray from a discharge generated in a discharge medium including a rare gas, the method comprising: a phosphorous material disposing step of disposing a phosphorous material at one or more positions being reachable for the ultraviolet ray; and a photocatalyst disposing step of disposing a photocatalyst at one or more positions being reachable for one or both of the ultraviolet ray and light emitted from the phosphorous material, so that the photocatalyst is in contact with the discharge medium.

With this arrangement, it is possible to dispose the photocatalyst having a self-cleaning function in the area.

(16) The method of any of (14) and (15), wherein a nitriding process is performed on the photocatalyst in order to adjust an absorption edge of the photocatalyst.

By performing a nitriding process on the photocatalyst so as to adjust the absorption edge to the predetermined wavelength, it is possible to efficiently utilize the light irradiated onto the photocatalyst and to help the photocatalyst exert its catalytic function; therefore, the self-cleaning function is more efficiently exerted.

(17) A method of manufacturing a plasma display panel in which a first substrate and a second substrate oppose each other and are sealed together around edges thereof, the first substrate having a plurality of ribs formed thereon, the method comprising: a mixture preparing step of preparing a mixture of phosphor particles and a photocatalyst; a precursor disposing step of disposing the mixture in at least one of areas provided between the ribs so as to form a precursor of a phosphor layer on one or more of walls that surround the area; and a phosphor layer forming step of forming the phosphor layer by baking the precursor.

With this arrangement, after the phosphor particles and the photocatalyst are mixed together, when the phosphor material precursor is disposed, the photocatalyst that has been mixed therein is also disposed; therefore, it is possible to dispose the photocatalyst having a self-cleaning function in the area, without having another step of disposing the photocatalyst.

(18) A method of manufacturing a plasma display panel in which a first substrate and a second substrate oppose each other and are sealed together around edges thereof, the first substrate having a plurality of ribs formed thereon, the method comprising: a phosphorous material disposing step of disposing a phosphorous material at one or more positions being reachable for an ultraviolet ray; and a photocatalyst disposing step of disposing a photocatalyst at one or more positions on at least one of the first substrate and the second substrate, the positions being reachable for one or both of the ultraviolet ray and light emitted from the phosphorous material, so that the photocatalyst is in contact with a discharge medium in the plasma display panel.

With this arrangement, it is possible to dispose the photocatalyst having a self-cleaning function in the area.

(19) The method of any of (17) and (18), wherein a nitriding process is performed on the photocatalyst.

By performing a nitriding process on the photocatalyst so as to adjust the absorption edge to the predetermined wavelength, in accordance with the wavelength of the light irradiated onto the photocatalyst, it is possible to efficiently utilize the self-cleaning function.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a schematic cross sectional view of a PDP of the prior art;

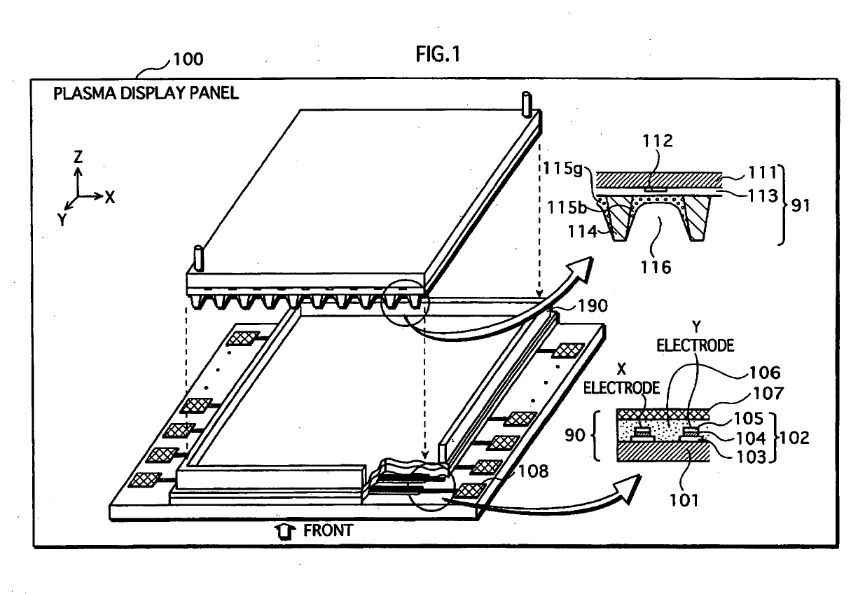

FIG. 2 shows the outline of the process of eliminating impurity gases;

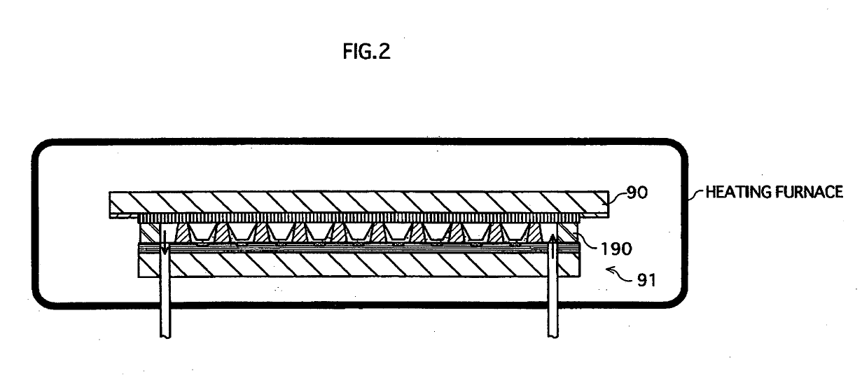

FIG. 3 is a schematic cross sectional view of the PDP of an embodiment of the present invention;

FIG. 4 is an enlarged cross sectional view of a cell in the PDP of an embodiment of the present invention;

FIG. 5 shows the results of luminance deterioration tests;

FIG. 6 shows a first modification example for the PDP of the embodiment of the present invention, with regard to where the photocatalyst is disposed;

FIG. 7 shows a second modification example for the PDP of the embodiment of the present invention, with regard to where the photocatalyst is disposed;

FIG. 8 shows a third modification example for the PDP of the embodiment of the present invention, with regard to where the photocatalyst is disposed; and

FIG. 9 shows a fourth modification example for the PDP of the embodiment of the present invention, with regard to where the photocatalyst is disposed.

### DESCRIPTION OF THE PREFERRED EMBODIMENTS

Structure

The following explains the PDP 195 in an embodiment of the present invention.

The PDP 195 is an AC-type Plasma Display Panel wherein deterioration, over the course of time, of the luminance of emitted light is inhibited.

The structure of the rear substrate of the PDP 195 is different from that of the conventional PDP 100.

More specifically, in the PDP 195, a photocatalyst 200 is interposed between the dielectric layer 113 and each of the phosphor layers 115r, 115g, or 115b.

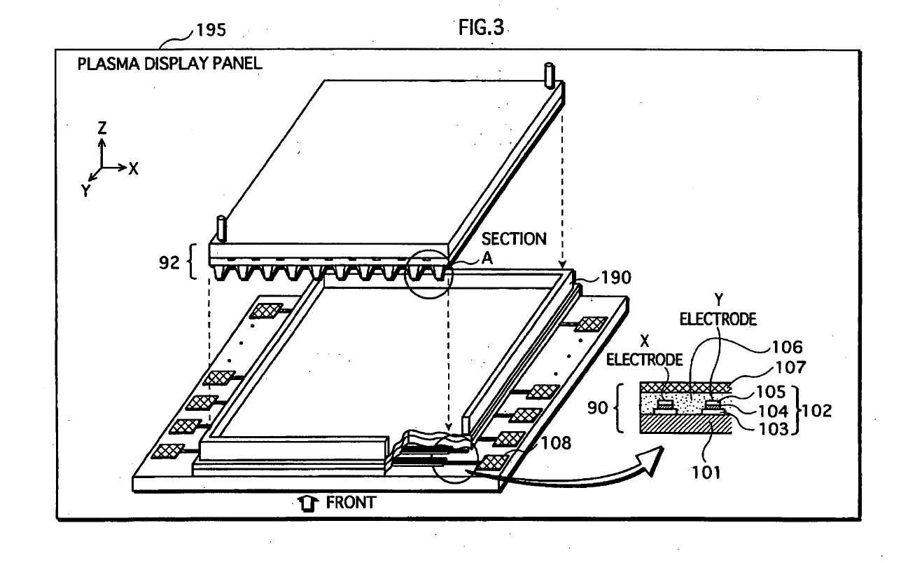

FIG. 3 is a schematic drawing of the PDP 195 of the present embodiment.

The PDP 195 includes a vessel which is made up of the front plate 90 and the rear plate 92, (i) whose main surfaces oppose each other and (ii) which are hermitically sealed together around the edges with the fused sealing glass 190. A discharge space 116 is formed inside the vessel.

Like in the conventional PDP 100, the front panel 90 is structured with a front glass substrate 101, on which display electrodes 102 and the dielectric layer 106 are disposed, and further covered by a protective layer 107 made of magnesium oxide (MgO)

A display electrode 102 comprises a transparent electrode 103, a black electrode film 104, and a bus electrode 105.

Due to the black color of ruthenium oxide, which is the main component of the black electrode film 104, the black electrode film 104 has a function of preventing external light from reflecting toward the front of the glass.

The main component of the bus electrode 105 is silver, which has high conductivity; therefore, the bus electrode 105 has a function of lowering the overall electric resistance value.

Here, for the sake of convenience, a combination of a black electrode film 104 and a bus electrode 105 will be referred to as a multi-layer electrode 309.

A multi-layer electrode 309 has, on one end of the length, a square-shaped terminal 108, being an electrode partially enlarged widthwise and serving as an interface to make connection with the driving circuit.

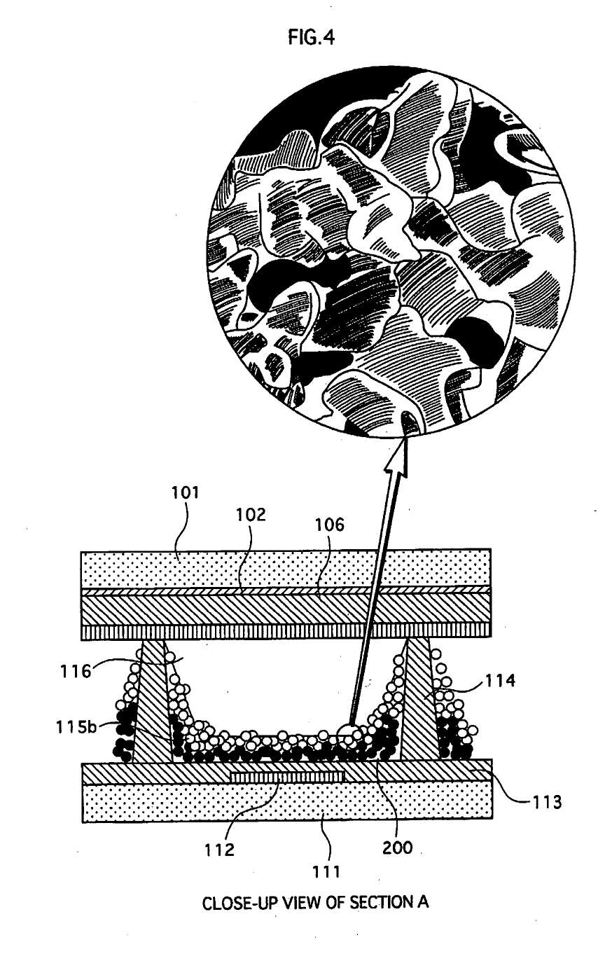

As shown in FIG. 4, the rear plate 92 comprises a rear glass substrate 111, address electrodes 112, a dielectric layer 113, ribs 114, and phosphor layers 115r, 115g, 115b, and a photocatalyst 200. The phosphor layers 115r, 115g, and 115b are formed on the wall surfaces of the grooves between the ribs 114 and correspond to the colors or red, green, and blue, respectively.

Like in the PDP 100, a discharge gas (an enclosed gas) containing a rare gas, for example, He, Xe, or Ne, is enclosed in the discharge space 116, with a pressure of approximately 500 to 600 Torr (66.5 to 79.8 kPa). The area defined by a pair of display electrodes 102 positioned adjacent to each other and an address electrode 112 that intersects the display electrodes 102 with the discharge space 116 intervening therebetween is a cell that contributes to image display.

In the discharge space 116, vacuum ultraviolet rays (substantially, having a wavelength of 147 nm) are generated due to discharges, and the phosphor layers 115r, 115g, and 115b respectively corresponding to the colors of red, green and blue are excited and emit light. This is how color display is performed.

The photocatalyst 200 forms a layer (0.1 μm to 20 μm in thickness) on the wall surfaces in the grooves provided between the ribs 114, in other words, forms a layer on the dielectric layer 113 and on the side walls the ribs 114.

The photocatalyst is a material that serves as an oxidation catalyst that decomposes impurities by oxidation when light is irradiated thereon, and therefore has what is called a self-cleaning function. In the present embodiment, the photocatalyst is, for example, TiO₂ in the anatase form (permittivity: 15 to 70).

TiO₂ in the anatase form has a high capability of activating oxygen (hereafter, referred to as “activation capability”) and has an absorption edge within the wavelength band of an ultraviolet-ray range or the blue wavelength band. TiO₂ in the anatase form has a disposition to generate active oxygen, when absorbing light having the same wavelength as the absorption edge.

As additional information, it is generally known that TiO₂ may be in the rutile form or the brookite form, besides the anatase form; however, according to the results of the evaluation tests that will be mentioned later, it is not effective to use TiO₂ in the rutile form or in the brookite form as a photocatalyst, because the activation capability is low, and it is difficult to achieve the desired effects.

In the embodiment, the photocatalyst prevents, with its oxidation function, impurities such as a hydrocarbon included in a discharge medium from being deposited as a solid carbide, as well as decomposes, by oxidation, the carbide cumulated on the surface of the phosphor layer by chemically changing the deposited carbide into COₓ gas.

In other words, a solid carbide that could block light turns into a part of transparent gas; therefore, it is possible to inhibit the deterioration of the luminance of emitted light in the PDP.

In order to generate active oxygen this way, it is necessary that the position of the conduction band in a band model is above the hydrogen-generation potential, and also the upper limit of the valence band is below the oxygen-generation potential.

A material used as the photocatalyst in the embodiment should satisfy at least the conditions above, and more specifically, the examples include, in addition to TiO₂ in the anatase form, SrTiO₃, ZnO, SiC, GaP, CdS, CdSe, and MOS₃.

Further, since the position of the conduction band shifts upward when a material is in the form of particulates, other materials such as SnO₂, WO₃, Fe₂O₃, Bi₂O₃ are also able to generate active oxygen when they are each in the form of particulates of 1 to 10 nm. Thus, these materials could be used as the photocatalyst in the embodiment.

The phosphor layers 115r, 115g, and 115b, which correspond to the colors of red, green, and blue, respectively, are each disposed on the photocatalyst 200.

The photocatalyst 200 has a higher reflectance than each of the phosphor layers 115r, 115g, and 115b. The photocatalyst 200 reflects the light emitted from the phosphor layer disposed thereon toward the direction of the front panel 90, and therefore enhances the luminous efficiency.

As shown in FIG. 4, each of the phosphor layers is a porous body in which a large number of phosphor particles are bonded with one another with gaps (pores) therebetween. The molecules of the discharge gas are able to pass through the phosphor layer.

Method of Forming the Photocatalyst 200

Like most of other components of the PDP, the photocatalyst 200 is formed by printing or applying an organic paste, which includes photocatalyst, onto the wall surfaces of the grooves and baking it.

Method of Forming the Phosphor Layers 115r, 115g, and 115b

Each of the phosphor layers 115r, 115g, and 115b is formed by printing or applying an organic paste, which includes a phosphorous material, over the photocatalyst 200 and baking it.

Tests for Evaluating Deterioration of Luminance of Emitted Light

The inventors performed tests with the PDP 195 for identifying the levels of deterioration, over the course of time, of the luminance of emitted light.

Specifications of the PDPs

Embodiment Sample 1

Position of the photocatalyst: beneath each phosphor layer

Thickness of the photocatalyst: 5 μm

Material used as the photocatalyst: TiO₂ (in the anatase form)

Absorption Edge: 380 nm to 420 nm (within the ultraviolet-ray range)

Others: Same as the Prior Art Sample below

Prior Art Sample

Photocatalyst included: None (Structured in the same manner as the PDP 100)

Comparison Sample 1

Position of the photocatalyst: beneath each phosphor layer

Thickness of the photocatalyst: 5 μm

Material used as the photocatalyst: TiO₂ (in the rutile form)

Absorption Edge: 380 nm to 420 nm (within the ultraviolet-ray range)

Others: Same as the Prior Art Sample above

Test Conditions

Ambient Temperature: 25 degrees centigrade

Amount of ultraviolet rays in the ambience: 0

Altitude: 10 meters above sea level

Testing Procedure

For each of the Embodiment Sample 1, the Prior Art Sample, and the Comparison Sample 1, the luminance values of the light emitted from predetermined cells are measured at the beginning of the driving period of the PDP, so as to calculate an average luminance of the emitted light, the mean value, “A”. Then, the luminance values of the light emitted from the same cells are measured after the PDP is driven for 1000 hours without an interruption, so as to calculate an average luminance of emitted light, the mean value “B”. By dividing the mean value “B” by the mean value “A” and multiplying the quotient by 100, the Luminous Intensity Sustainability (%) is calculated.

Test Results

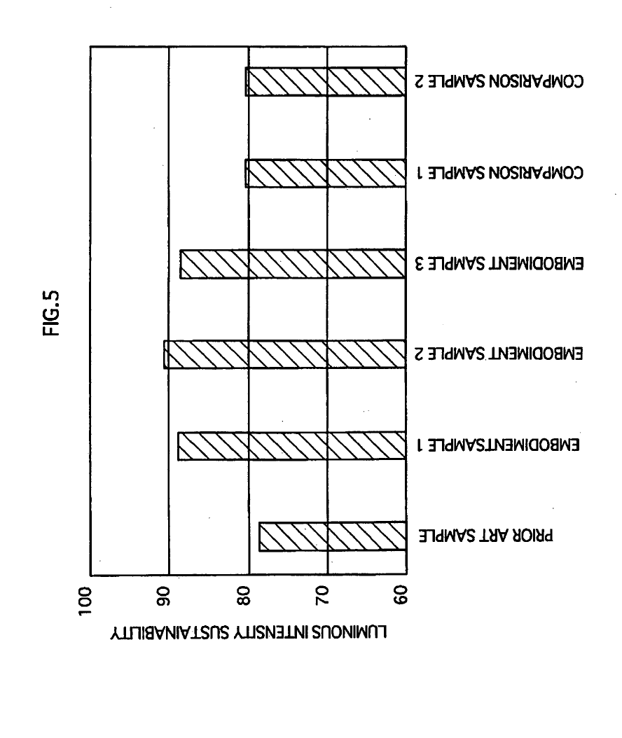

As shown in FIG. 5, as for the Luminous Intensity Sustainability, the Prior Art Sample showed approximately 79%, whereas the Embodiment Sample 1 showed approximately 89%. There was a difference of as large as 10 points, and it was observed that the deterioration, over the course of time, of the luminance of emitted light in the Embodiment Sample 1 was inhibited.

The Luminous Intensity Sustainability of the Comparison Sample 1 was approximately 81%. There was a difference of only approximately 3 points from the Prior Art Sample, and effects of inhibiting the deterioration, over the course of time, of the luminance of emitted light were not observed.

In conclusion, it is not appropriate to expect TiO₂ in the rutile form to have the effects as the photocatalyst of the present embodiment, i.e. to have the self-cleaning action.

Setting an Absorption Edge of the Photocatalyst

In recent years, it has been reported that when a nitriding process, a chromium ion doping process, or a dye sensitizer absorption process is performed on a photocatalyst such as TiO₂, CdS, and InTaO₄, the photocatalyst obtains activation capability from not only ultraviolet rays but also visible light.

The inventors noted this fact and found a way of having photocatalyst activate oxygen by purposefully utilizing visible light emitted from a phosphorous material.

More specifically, the inventors came up with an idea that it is possible to activate oxygen more efficiently by disposing a photocatalyst beneath each phosphor layer, the photocatalyst having an absorption edge within the wavelength band of the light emitted from each of the phosphor layers corresponding to the colors or red, green and blue.

In order to prove that this idea is valid, the inventors performed a test using a blue phosphorous material, because deterioration of the luminance of the light emitted from a blue phosphorous material is prominent when a carbide adheres thereto.

More specifically, an Embodiment Sample 2 is prepared by disposing TiO₂ having an absorption edge within the blue wavelength band, beneath a phosphorous material which is of Europium-Activated Barium Magnesium Aluminate and emits blue light. The same test as mentioned above, which is for evaluating the deterioration of the luminance of emitted light, was performed on the Embodiment Sample 2, as well.

Specification of the PDP

Embodiment Sample 2

Position of the photocatalyst: beneath each phosphor layer

Thickness of the photocatalyst: 5 μm

Material used as the photocatalyst: TiO₂ (in the anatase form)

Absorption Edge: 380 nm to 550 nm (within the visible light range)

Others: Same as the Prior Art Sample

As shown in FIG. 5, as for the Luminous Intensity Sustainability, the Embodiment Sample 2 showed approximately 91%. There was a difference of about 12 points, and it was observed that the deterioration, over the course of time, of the luminance of emitted light in the Embodiment Sample 2 was inhibited.

In addition, since the Luminous Intensity Sustainability of the Embodiment Sample 2 is higher than that of the Embodiment Sample 1 by approximately 2 points, the Embodiment Sample 2 has the same inhibitive effects as the Embodiment Sample 1 does.

As explained so far, according to the present embodiment, when a photocatalyst is disposed beneath the phosphor layer in a PDP, it is possible to inhibit carbides from depositing onto the walls inside the PDP, including the surfaces of the phosphorous materials, by decomposing the carbides with the oxygen activation function of the photocatalyst, while maintaining the luminous intensity at the same level as in a conventional product.

It should be noted that, in the present embodiment, the photocatalyst 200 is TiO₂ in the anatase form is disposed so as to form a layer; however, it is also acceptable if TiO₂ in the anatase form is disposed as being impregnated into a base of glass beads, glass wool, activated carbon powder, copper powder, alumina particles, or the like.

In such cases, it is possible to apply glass beads or alumina particles with an average particle diameter of some nanometers to some millimeters.

In addition, in the present embodiment, the photocatalyst is disposed beneath the phosphor layer; however, the positions for disposing the photocatalyst is not limited to this, and it is acceptable to dispose the photocatalyst at any location as long as it is inside the PDP and reachable for one or both of the ultraviolet rays and the light emitted from the phosphorous material, and also the photocatalyst is in contact with the discharge gas.

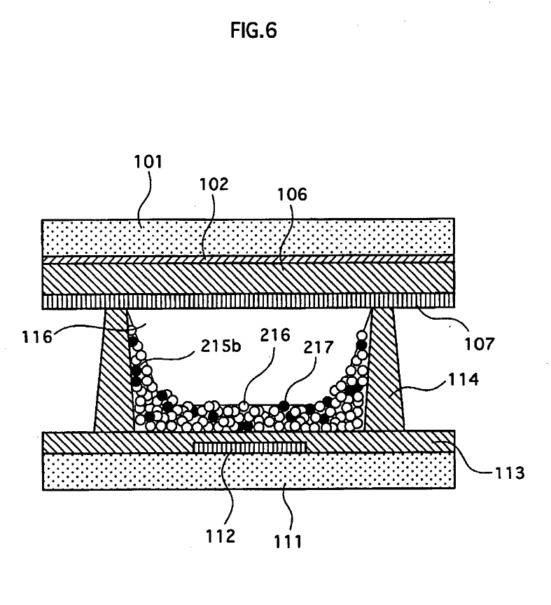

For example, as shown in FIG. 6, it is acceptable to dispose a phosphor layer 215b in which phosphorous particles 216 and photocatalyst particles 217 are mixed (hereafter, referred to as “a phosphor layer including a photocatalyst”), on the wall surfaces of the grooves.

In this case, since the phosphor particles 216 are in contact with the photocatalyst particles 217, the action of decomposing, with use of the photocatalyst particles 217, the carbide adhering to the surfaces of the phosphor particles 216 is strong.

The following explains a typical method of forming a phosphor layer including a photocatalyst:

Method of Forming a Phosphor Layer Including a Photocatalyst:

1. Process of Preparing a Phosphor Precursor

Photocatalyst fine powder is mixed into an organic paste, which serves as a phosphor precursor in the process of forming a phosphor layer. The mixture is stirred to make the content uniform.

2. Process of Disposing the Phosphor Precursor

The phosphor precursor, which has been made to be uniform, is applied or printed so as to form a phosphor layer at an intended position.

3. Process of Forming a Phosphor Layer

The phosphor precursor is baked so as to obtain a phosphor layer from which organic elements are eliminated.

Tests for Evaluating Deterioration of Luminance of Emitted Light

In order to confirm the effect of the phosphor layer including a photocatalyst for inhibiting the deterioration of the luminance, the same test as mentioned above, which is for evaluating deterioration of the luminance of emitted light, were performed on an Embodiment Sample 3 and a Comparison Sample 2 having the following specifications:

Specifications of the PDPs

Embodiment Sample 3

Position of the photocatalyst: distributed throughout the phosphorous material

Thickness of the phosphor layer including a photocatalyst: 20 μm

Weight percentage of the photocatalyst to the phosphorous material: 3%

Material used as the photocatalyst: TiO₂ (in the anatase form)

Absorption Edge: 380 nm to 420 nm (within the ultraviolet-ray range)

Others: same as the Prior Art Sample above

Comparison Sample 2

Position of the photocatalyst: distributed throughout the phosphorous material

Thickness of the phosphor layer including a photocatalyst: 20 μm

Weight percentage of the photocatalyst to the phosphorous material: 3%

Material used as the photocatalyst: TiO₂ (in the rutile form)

Absorption Edge: 380 nm to 420 nm (within the ultraviolet-ray range)

Others: same as the Prior Art Sample above

Test Results

As shown in FIG. 5, as for the Luminous Intensity Sustainability, the Prior Art Sample showed approximately 79%, where as the Embodiment Sample 3 showed approximately 89%. There was a difference of as large as 10 points, and it was observed that the deterioration, over the course of time, of the luminance of emitted light in the Embodiment Sample 3 was inhibited.

The Luminous Intensity Sustainability of the Comparison Sample 2 was approximately 81%. There was a difference of only approximately 3 points from the Prior Art Sample, and effects of inhibiting the deterioration, over the course of time, of the luminance of emitted light were not observed.

In conclusion, like the Comparison Sample 1, it is not appropriate to expect TiO₂ in the rutile form, even while existing within a phosphor layer, to have the effects as the photocatalyst of the present embodiment, i.e. to have the self-cleaning action.

How to Identify TiO₂ in the Anatase Form

One of the methods used to identify TiO₂ in the anatase form is to study crystal structures with an X-ray diffraction device.

More specifically, the lattice constant “c” is measured with use of an X-ray diffraction device.

Judgment Criterion

TiO₂ in the anatase form: Tetragonal; the lattice constant c is 9.49

Cf. TiO₂ in the rutile form: Tetragonal; the lattice constant c is 2.96

Other Examples of Positions at Which a Photocatalyst is to be Disposed

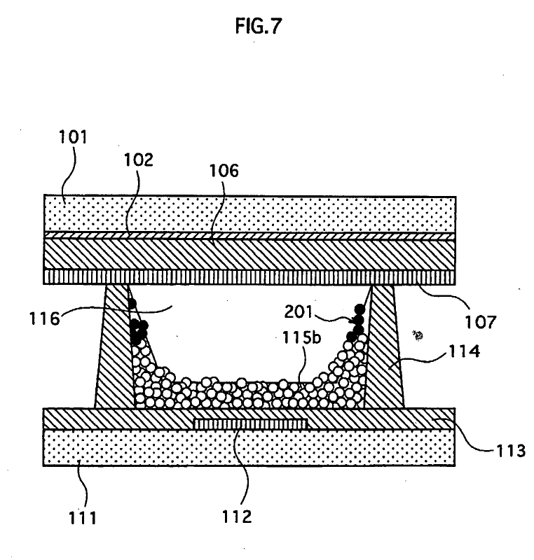

As shown in FIG. 7, it is also acceptable to dispose a photocatalyst 201 in the vicinity of the tips of the ribs 114.

A phosphor layer disposed on a plane opposing the front glass substrate 101, the plane namely being the dielectric layer 113, has a large influence on the luminance of emitted light; therefore, it would be desirable that no photocatalyst is disposed in the vicinity of the surface of the phosphor layer. Thus, the photocatalyst 201 that exists in the vicinity of the tips of the ribs as mentioned above hardly deteriorates the luminous intensity.

Further, because a discharge is generated in the vicinity of the display electrode 102, the closer it is to the tip of a rib, the more intense an ultraviolet ray is; therefore, the self-cleaning function is more effective this way.

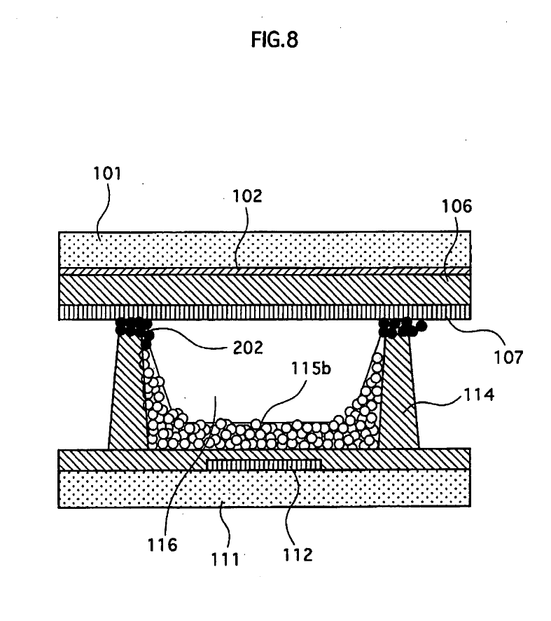

Also, as shown in FIG. 8, it is also effective to dispose a photocatalyst 202 at the tops of the ribs 114.

Usually, no phosphorous material is disposed at the tops of the ribs, and even when some phosphorous material is disposed, it does not influence the luminous characteristics.

Consequently, when a photocatalyst is disposed at the tops of the ribs, light emitted from the phosphorous material will not be hindered. In addition, since the photocatalyst is in contact with the front plate 90, ultraviolet rays that activate the photocatalyst are strong, and the effect of the photocatalyst is further enhanced.

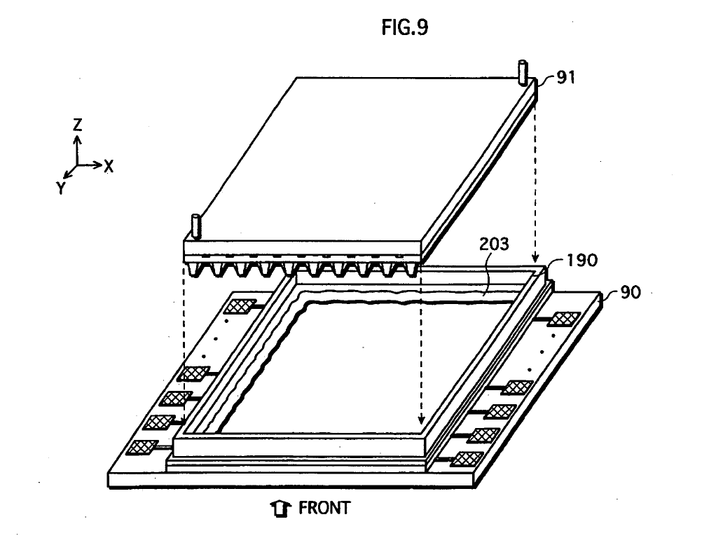

As shown in FIG. 9, it is also acceptable to dispose a photocatalyst 201 along the inner walls of the sealing glass 190 on the front plate 90. This way, the photocatalyst 201 is disposed outside the area being used to display images, in other words, outside the area in which cells are provided.

The inner walls of the sealing glass 190 are where the discharge gas passes through and also have an even surface; therefore, it is easy to apply or print a photocatalyst.

The sealing glass 190 is formed by baking a material in which an organic paste and glass is mixed. Thus, in the vicinity of the sealing glass 190, a relatively larger amount of impurities from organic substances exist, and deterioration of the luminance of emitted light is more likely to occur, than at the center of the panel.

Accordingly, it is effective to dispose a photocatalyst in the vicinity of the sealing glass 190 outside the image display area.

When a photocatalyst is disposed outside the image display area, the photocatalyst is away from the display electrodes 102 where discharges are generated; however, because the ultraviolet rays from the discharges generated inside the cells positioned in the vicinity of the inner walls of the sealing glass 190 are to reach the photocatalyst, the self-cleaning function is available.

The photocatalyst disposed around the inner walls of the sealing glass 190 is able to exert its self-cleaning function also when natural light enters through the front panel 90 from the front of the panel.

As additional information, although FIG. 9 shows that the photocatalyst 201 is disposed along the inner walls of the sealing glass 190 on the front plate 90 side, it is also acceptable that the photocatalyst 201 is disposed along the inner walls of the sealing glass 190 on the back plate 91 side.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A light emitting device that emits visible light caused by an ultraviolet ray from a discharge generated in a discharge medium including a rare gas, the light emitting device comprising:
a vessel that is hermetically sealed and contains the discharge medium;
a phosphorous material disposed in the vessel; and
one or more photocatalysts that (i) are disposed at one or more first areas inside the vessel, the first areas being reachable for one or both of the ultraviolet ray and light emitted from the phosphorous material, and (ii) are in contact with the discharge medium.

2. The light emitting device of claim 1, wherein
the light emitting device is a plasma display panel,
the vessel is made of at least a first substrate and a second substrate that oppose each other and are sealed together around edges thereof,
a plurality of ribs are formed on the first substrate,
in each of at least one of second areas provided between the ribs, the phosphorous material forms one or more phosphor layers on one or more walls that surround the second area, and
at least one of the photocatalysts is disposed at one or more positions selected from (i) anywhere in the second area in which the phosphor layer is formed and (ii) at a top of at least one of the ribs that sandwich the second area in which the phosphor layer is formed.

3. The light emitting device of claim 2, wherein
at least one of the photocatalysts is disposed so as to be distributed throughout one or more of the phosphor layers.

4. The light emitting device of claim 2, wherein
the phosphor layers are porous so as to allow the discharge medium to pass through, and
at least one of the photocatalysts is disposed so as to be (i) positioned between at least one of the phosphor layers and the first substrate, and (ii) in contact with the at least one of the phosphor layers.

5. The light emitting device of claim 2, wherein
the phosphor layers are porous so as to allow the discharge medium to pass through, and
at least one of the photocatalysts is disposed so as to be (i) positioned between at least one of the ribs and the phosphor layer formed over a surface thereof, and (ii) in contact with this phosphor layer.

6. The light emitting device of claim 2, wherein
at least one of the photocatalysts is disposed at one or more positions selected from (i) at a top of at least one of the ribs and (ii) in vicinity of such a top.

7. The light emitting device of any of claims 3, 4, 5, and 6, wherein
when absorbing an ultraviolet ray, each phosphor layer emits light in a color that is common to the phosphor layers in that second area, the color being one of red, green, and blue, and
at least one of the photocatalysts has an absorption edge within a wavelength band of the color of blue in a visible light range and is disposed in vicinity of the phosphor layer that emits light in the color of blue.

8. The light emitting device of any of claims 3, 4, 5, and 6, wherein
when absorbing an ultraviolet ray, each phosphor layer emits light in a color that is common to the phosphor layers in that second area, the color being one of red, green, and blue,
the photocatalysts each have an absorption edge in one of two or more wavelength bands that are different from each other, and
which wavelength band the absorption edge of each photocatalyst is within is determined according to the color of the light emitted from the phosphor layer that is disposed in vicinity thereof.

9. The light emitting device of any of claims 3, 4, 5, and 6, wherein
all the second areas each have at least one of the photocatalysts disposed therein.

10. The light emitting device of any of claims 3, 4, 5, and 6, wherein
a main component of each of the photocatalysts is TiO₂ in anatase form.

11. The light emitting device of claim 10, wherein
at least one of the photocatalysts has an absorption edge within a visible light range.

12. The light emitting device of claim 1, wherein
the light emitting device is a plasma display panel,
the vessel is made of at least a first substrate and a second substrate that oppose each other and are sealed together around edges thereof, and
the one or more photocatalysts are disposed outside an image display area in which the phosphorous material is disposed.

13. The light emitting device of claim 12, wherein
the photocatalysts are disposed in vicinity of the edges of at least one of the first and the second substrates.

14. A method of manufacturing a light emitting device that emits visible light caused by an ultraviolet ray from a discharge generated in a discharge medium including a rare gas, the method comprising:
a precursor preparing step of preparing a precursor of a phosphor layer by mixing phosphor particles and a photocatalyst;
a precursor disposing step of disposing the precursor at one or more positions being reachable for the ultraviolet ray, so that the precursor is in contact with the discharge medium; and
a phosphor layer forming step of forming a phosphor layer by baking the precursor.

15. A method of manufacturing a light emitting device that emits visible light caused by an ultraviolet ray from a discharge generated in a discharge medium including a rare gas, the method comprising:
a phosphorous material disposing step of disposing a phosphorous material at one or more positions being reachable for the ultraviolet ray; and
a photocatalyst disposing step of disposing a photocatalyst at one or more positions being reachable for one or both of the ultraviolet ray and light emitted from the phosphorous material, so that the photocatalyst is in contact with the discharge medium.

16. The method of any of claims 14 and 15, wherein
a nitriding process is performed on the photocatalyst in order to adjust an absorption edge of the photocatalyst.

17. A method of manufacturing a plasma display panel in which a first substrate and a second substrate oppose each other and are sealed together around edges thereof, the first substrate having a plurality of ribs formed thereon, the method comprising:
a mixture preparing step of preparing a mixture of phosphor particles and a photocatalyst;
a precursor disposing step of disposing the mixture in at least one of areas provided between the ribs so as to form a precursor of a phosphor layer on one or more of walls that surround the area; and
a phosphor layer forming step of forming the phosphor layer by baking the precursor.

18. A method of manufacturing a plasma display panel in which a first substrate and a second substrate oppose each other and are sealed together around edges thereof, the first substrate having a plurality of ribs formed thereon, the method comprising:
a phosphorous material disposing step of disposing a phosphorous material at one or more positions being reachable for an ultraviolet ray; and
a photocatalyst disposing step of disposing a photocatalyst at one or more positions on at least one of the first substrate and the second substrate, the positions being reachable for one or both of the ultraviolet ray and light emitted from the phosphorous material, so that the photocatalyst is in contact with a discharge medium in the plasma display panel.

19. The method of any of claims 17 and 18, wherein
a nitriding process is performed on the photocatalyst.
